(19) United States
(12) Patent Application Publication
(10) Pub. No.: US 2008/0170535 A1
(43) Pub. Date: Jul. 17, 2008

(54) METHOD AND APPARATUS FOR MANAGING SERVICE FLOW BASED ON RELAY STATION

(75) Inventor: Ruobin Zheng, Shenzhen (CN)

Correspondence Address: DARBY & DARBY P.C., P.O. BOX 770, Church Street Station, New York, NY, 10008-0770, US

(73) Assignee: HUAWEI TECHNOLOGIES CO., LTD., Shenzhen (CN)

(21) Appl. No.: 12/045,398

(22) Filed: Mar. 10, 2008

Related U.S. Application Data
(63) Continuation of application No. PCT/CN2006/002325, filed on Sep. 8, 2006.

(30) Foreign Application Priority Data
Sep. 9, 2005 (CN) 200510099800.4

(51) Int. Cl. H04B 7/14

(52) U.S. Cl. 370/315

(57) ABSTRACT

A method and system for managing service flows based on a Relay Station (RS). The method includes the steps of establishing a mapping relation of a connection between an RS and Subscriber Station/Mobile Subscriber Station (SS/MSS) and a connection between a BS and RS in an RS; transforming a connection identification in a data packet according to the mapping relation established, and then implementing an interaction of the data packet between the BS and SS/MSS according to the transformed connection identification. An SFID and related properties (i.e. QoS binding) of a flow can be uniformly managed in the BS, so that the RS only implements a connecting re-mapping function. Therefore, the complexity of the RS can be decreased effectively. Furthermore, there is no need to move the flow status in the handoff process, and the handoff time delay can be decreased effectively.

### CROSS REFERENCE TO RELATED APPLICATIONS

This application is a continuation of International Patent Application No. PCT/CN2006/002325, filed Sep. 8, 2006, which claims priority to Chinese Patent Application No. 200510099800.4, filed Sep. 9, 2005, all of which are hereby incorporated by reference in their entireties.

### FIELD OF THE TECHNOLOGY

The present invention relates to communications, and particularly to a method and apparatus for managing service flows based on a Relay Station (RS).

### BACKGROUND OF THE INVENTION

IEEE 802.16 is the standard of broadband wireless access. IEEE 802.16 mainly has two editions: broadband fixed wireless access edition 802.16-2004 of 802.16 standard, and broadband mobile wireless access edition 802.16e of the 802.16 standard. The 802.16 protocol based on the layered model as shown in FIG. 1 defines the Physical (PHY) Layer and Media Access Control (MAC) layer of 802.16. The data link layer can be divided into a Service Specific Convergence Sublayer (shorted as SSCS or CS), a MAC Common Part Sublayer (MAC CPS) and a Security Sublayer (SS).

The following functions are mainly implemented in the SS:

receiving a Protocol Data Unit (PDU) from a higher protocol layer;
classifying the PDU of higher layer;
payload Head Suppression (PHS) or decompression;
forming the PDU of the CS;
transferring the CS PDU to the function entity of next layer (namely MAC CPS); and
receiving the CS PDU from the equity entity of opposite side.

The following functions are accomplished in the CPS:

generating a MAC PDU;
managing service flows;
managing bandwidth allocation;
controlling the Automatic Repeat Request (ARQ); and
dividing and recombining, etc.

Managing service flows in the CPS is divided into two parts: Service Flow Identification (SFID)/Connection Identification (CID) assignment (SFID/CID assignment, or “flow assignment”) and SFID/CID Mapping (SFID/CID mapping, or “connection mapping”).

The process of managing flow assignment mainly provides for a SFID/CID to be assigned to each service flow, and for the association of the service flows and related properties.

The related properties may include: Direction, CID, Provisioned QoS Parameters, Admitted QoS Parameters, Active QoS Parameters, Classifier rule, PHS rule and ARQ configuration etc.

The connection mapping mainly provides for one flow identified by SFID to be mapped to one special connection identified by the CID when the flow is activated. When the connection is established, the CID is available temporarily in a special area coverage, and may be changed dynamically.

In two editions of IEEE 802.16, 802.16-2004 Base Station (BS) and SS/MSS network elements, and 802.16e also defines BS and SS/MSS network elements.

Until now, a 802.16 Multi-hop relay search group has put forward the concept of WiMAX RS in order to extend the coverage range of the BS. However, the function frame and method for managing service flows based on a RS have not yet been put forward.

### SUMMARY OF THE INVENTION

Embodiments of the present invention provide a method for managing service flows based on a RS. In the present invention, the RS only implements connecting a re-mapping function. Therefore, the complexity of the RS can be decreased effectively. Furthermore, there is no need to migrate the flow status in the handoff process. Herewith, the handoff time delay can be decreased effectively.

The object of the present invention is implemented by the technical solution as follows.

A method for managing service flows based on a RS includes:

establishing a mapping relation between a first connection identification and a second connection identification in a RS;
transforming the first connection identification in a data packet to the second connection identification, according to the established mapping relation; and
implementing a data packet interaction between the RS and a BS, or a data packet interaction between the RS and another RS, or a data packet interaction between the RS and a Subscriber Station/Mobile Subscriber Station (SS/MSS), according to the transformed second connection identification.

A RS in accordance with the present invention includes:

a PHY layer configured to receive and send a data packet; and
a MAC layer configured to execute a MAC layer process to the data packet received by he PHY layer, to transform a first connection identification carried by the data packet to a second connection identification, and send the data packet to the PHY layer.

The MAC layer in accordance with the present invention includes:

a MAC CPS configured to execute a MAC common part process to the data packet and send the processed data packet to a connection re-mapping unit;
a connection re-mapping unit, set in the MAC CPS, configured to transform a first connection identification in the processed data packet to a second connection identification and to send the data packet to a SS; where
the SS is configured to execute a security process, and to send the processed data packet to the physical layer for processing.

It can be seen from above technical solution that, firstly, the present invention establishes the mapping relation between the first connection identification and the second connection identification in the RS; transforms the first connection identification in the data packet according to the established mapping relation, and implements a data packet interaction between the RS and a BS or a data packet interaction between the RS and other RS or a data packet interaction between the RS and a SS/MSS, according to the transformed second connection identification. In the present invention, the RS implements a connecting re-mapping function and transforming connection identification. Therefore, the complexity of the RS can be decreased effectively. Furthermore, there is no need to migrate the flow status in the switching process. Herewith, the handoff time delay can be decreased effectively.

In addition, the present invention uses the connection re-mapping of the second layer to solve the problem of multi-hop relay. Thereby, there is no need to introduce the technology of complicated routing in the third layer, the complexity of WiMAX relay network is reduced.

### BRIEF DESCRIPTION OF THE DRAWINGS

The invention will become more readily apparent from the Detailed Description of the Invention, which proceeds with reference to the drawings, in which:

FIG. 1 is a schematic diagram illustrating the layered model in accordance with the 802.16 protocol;

FIG. 2 is a schematic diagram illustrating the function frame of the BS and RS according to the first embodiment of the present invention;

FIG. 3 is a schematic diagram illustrating the function frame of the BS and RS according to the second embodiment of the present invention;

FIG. 4 is a schematic diagram illustrating working principle of multi-hop relay system according to the third embodiment of the present invention;

FIG. 5 is a schematic diagram illustrating working principle of one hop relay system according to one embodiment of the present invention; and

FIG. 6 is a flowchart illustrating the management on Dynamic Stream Changing (DSC) flow managing message according to one embodiment of the present invention.

### DETAILED DESCRIPTION OF THE INVENTION

The present invention provides a method for managing service flows and an RS. The core method includes the steps of: first establishing a mapping relation of a connection between the RS and a SS/MSS and a connection between a BS and a RS in the RS, transforming a connection identification in a data packet according to the established mapping relation, and implementing an interaction of the data packet between the BS and SS/MSS according to the transformed connection identification. The data packet includes flow information message and flow data message.

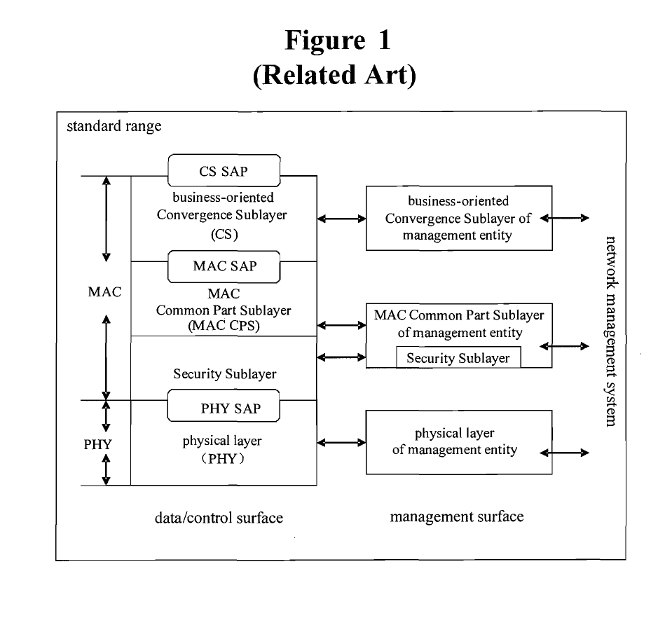

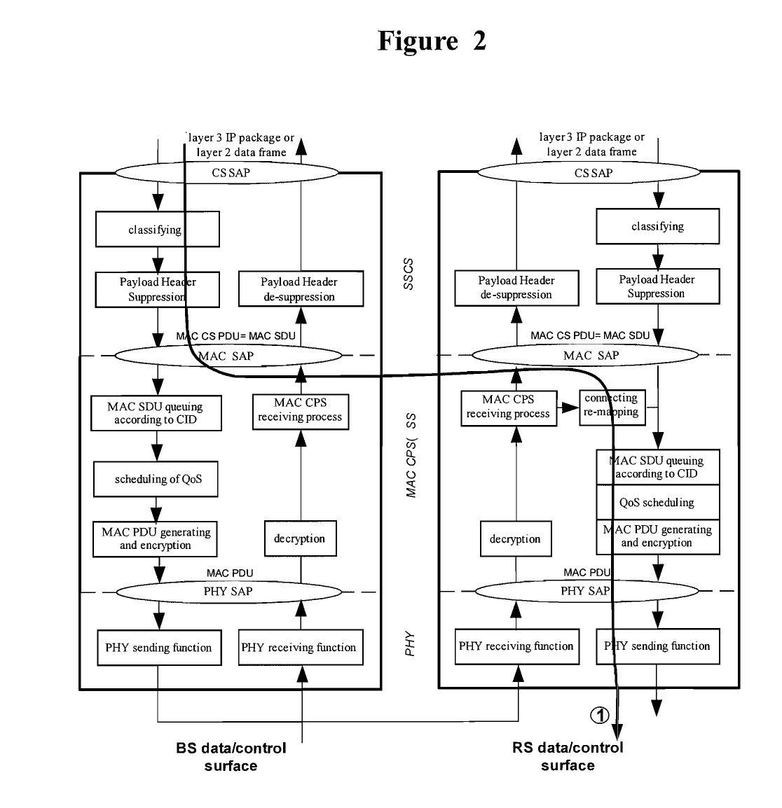

The first embodiment is provided for the system of the present invention as shown in FIG. 2. The system includes: a BS, a SS/MSS and a RS. Corresponding with the layered model of the 802.16 protocol in FIG. 1, the BS and the RS includes the MAC layer and PHY layer respectively. The MAC layer of the BS includes CS, MAC CPS and SS. The MAC layer of the RS includes MAC CPS and SS, and includes CS optionally. And connecting re-mapping unit is set in MAC CPS to support the relay ability of WiMAX.

When a data packet sent by the SS/MSS enters the MAC layer of the BS, the CS layer classifies the data packet, maps the data packet to corresponding connection which is represented by a connection identification CID_{BS-RS} between the BS and RS, and then sends the data packet to the MAC CPS of the BS after processed by Payload Head Suppression. The MAC CPS executes a process of MAC CPS receiving to the data packet and adds the MAC frame header. And the data packet is sent to the PHY layer of the BS. The PHY layer sends the data packet received to the RS of opposite side. The RS sends the data packet to the MAC layer after receiving the data packet through the PHY layer. The MAC layer removes the MAC frame header of the data packet through upstream MAC CPS after receiving the data packet. And then the MAC layer executes a process of receiving to the data packet, and sends the data packet to the connecting re-mapping unit of the MAC CPS. The connecting re-mapping unit transforms the connection identification in the processed data packet to the connection identification between the RS and SS/MSS, and then sends the data packet to downstream MAC CPS. The downstream MAC CPS sends the data packet to the PHY layer of the RS to execute a process of receiving after processing the data packet. The PHY layer sends the data packet to the SS/MSS of the opposite side.

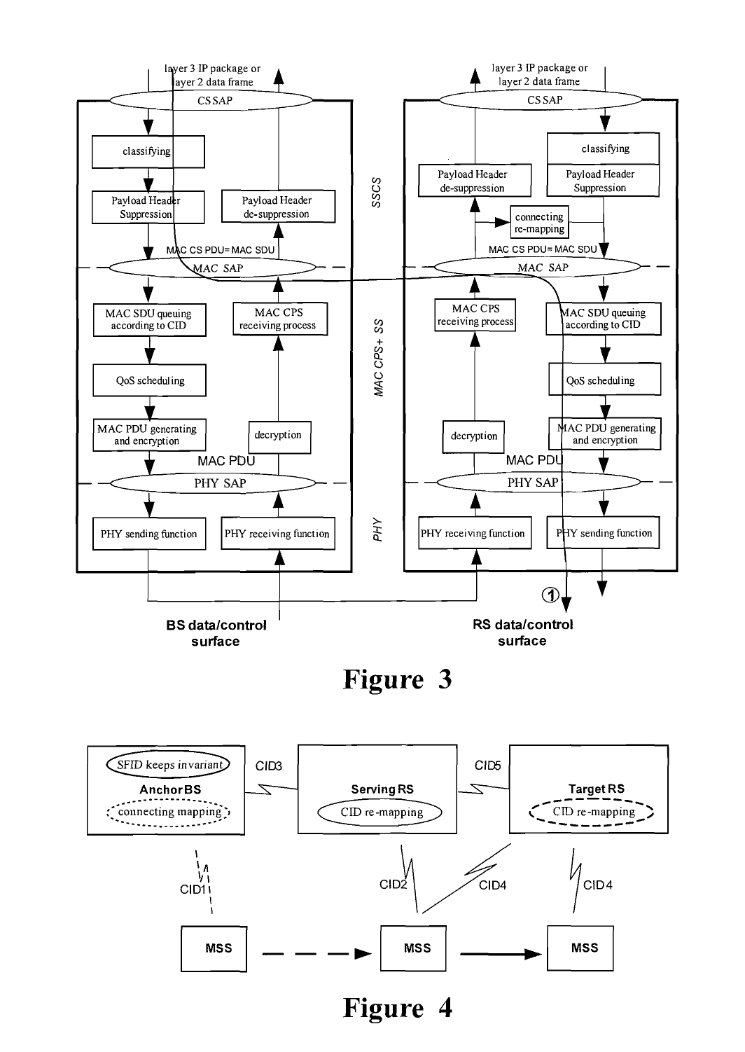

The second embodiment is provided for the system of the present invention as shown in FIG. 3. The differences between this embodiment and the first embodiment provided by the present invention are that the RS also includes CS and the connecting re-mapping unit which is arranged in the MAC CPS in the first embodiment is set in the CS of the RS to support the relay ability of WiMAX.

The data packet is sent to MAC layer after received by the RS through PHY layer. The MAC layer executes a process of removing the MAC frame header to the data packet through upstream MAC CPS after receiving the data packet. And then the MAC layer executes the process of receiving and sends the processed data packet to the connecting re-mapping unit of the CS. The connecting re-mapping unit transforms the connection identification in the processed data packet to the connection identification between the RS and SS/MSS, and then sends the data packet to downstream MAC CPS. The downstream MAC CPS sends the data packet to the PHY layer of the RS to execute a process of receiving after process the data packet. The PHY layer sends the data packet to the SS/MSS of the opposite side.

The above embodiments include one RS. The present invention also may have several RSs, that is, at least one RS included between the BS and RS belong to multi-hop RS relay system. To describe this embodiment expediently, the RS which connects to the MSS/SS is referred to as a “target RS”, while other RSs are still referred to as RSs. A third embodiment is provided including one RS and target RS in accordance with the system of the present invention.

The third embodiment is provided in accordance with the system of the present invention as shown in FIG. 4. The differences between this embodiment and the first embodiment and the second embodiment provided by the present invention are that this embodiment includes a BS, a SS/MSS, a middle RS and a target RS, and the BS and target RS are connected through the middle RS. The middle RS is the Serving RS as shown in FIG. 4.

When the data packet sent by SS/MSS enters the MAC layer of BS, the CS classifies the data packet and maps the data packet to corresponding connection which is represented by the connection identification CID_{BS-RS} between the BS and RS, and sends the data packet to the MAC CPS of the BS after processed by PHS. The MAC CPS executes the process of receiving to the data packet using MAC CPS, and sends the data packet to the PHY layer of the BS after adding the MAC frame header. The PHY layer sends the data packet received to the RS of the opposite side.

The RS executes a process of removing the MAC frame header to the data packet after receiving the data packet. And the RS executes the process of receiving to obtain a processed data packet. The connection identification in the processed data packet is transformed to the connection identification between the RS and target RS, and then the data packet is sent to corresponding target RS.

The target RS executes the process of removing the MAC frame header to the data packet. And then the target RS executes the process of receiving to the data packet, and obtains the processed data packet, and sends the processed message to the connecting re-mapping unit of CS after processing. The connection identification in the processed data packet is transformed to the connection identification between the RS and S/MSS, and then the data packet is sent to corresponding SS/MSS.

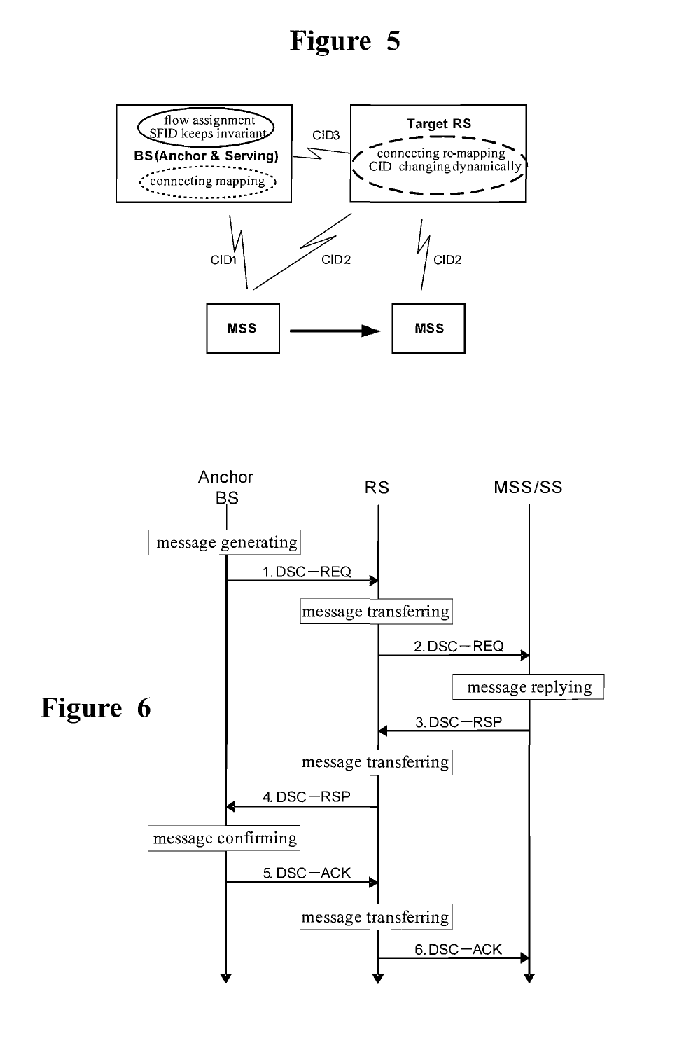

A fourth embodiment is provided in accordance with the method of the present invention. An example as mutual WiMAX DSC flow managing message between the BS and SS/MSS is illustrated in conjunction the schematic diagram of the system working principle as shown in FIG. 5.

In FIG. 5, the BS is not only an Anchor BS, but also a serving BS. The RS is a target RS. One hop Relay is between the BS and SS/MSS. The SFID is assigned by the BS when the SS/MSS applies to build a new flow. The CID from the SS/MSS to BS is assigned by the serving BS when the SS/MSS does not move. The CID from the SS/MSS to target RS is assigned by the target RS when the SS/MSS moves. When the SS/MSS is switched from the BS to RS, the flow or session communication to SS/MSS doesn't break off. That is, the SFID after assigned will keep invariant and be managed by the BS. The connection will change dynamically because the cell in which SS/MSS is located has changed. Just as the connection to SS/MSS in FIG. 5, the connection CID1 with BS changes to the connection CID2 with RS to implement the connecting re-mapping function. CID3 is the connection between the BS and RS.

An interaction process of the data packet between the BS and SS/MSS is implemented by the RS as follows:

First, the RS establishes the mapping relation of the connection between the RS and SS/MSS and the connection between the BS and RS according to the SFID carried by the received data packet and the connection identification CID_{SS/MSS-BS} between the SS/MSS and BS and the connection identification CID_{BS-RS} between the BS and RS. This process includes the following steps:

Step1: When the SS/MSS is connected to the BS, the network in which the BS is located in assigns the SFID/CID to the data packet connected by the SS/MSS based on the 802.16 standard, and establishes the mapping relation of the assigned SFID and the CID_{BS-SS/MSS}. Simultaneously, the mapping relation of the reverse CID_{SS/MSS-BS} and the assigned SFID is established.

Step2: The connection CID_{BS-RS} from the BS to RS is established through the BS in the process of the SS/MSS being switched from the BS to RS. And the new mapping relation of the CID_{BS-RS} and the assigned SFID is established according to the assigned SFID. Simultaneously, the reverse connection CID_{RS-BS} from the RS to BS is established. And the new mapping relation of the CID_{RS-BS} and the assigned SFID is established according to the assigned SFID. The new mapping relation is saved in the SFID/CID mapping table of the BS.

Step3: The RS establishes the connection CID_{RS-SS/MSS} from the RS to SS/MSS in the process of the SS/MSS being switched from the BS to RS. And the mapping relation of the connection identification CID_{RS-SS/MSS} from the RS to SS/MSS and the connection identification CID_{BS-RS} from the BS to RS is established according to the assigned SFID, and the connection identification CID_{BS-RS} from the BS to RS. Simultaneously, the reverse connection CID_{SS/MSS-RS} from the SS/MSS to RS is established. And the mapping relation of the connection identification CID_{SS/MSS-RS} from the SS/MSS to RS and the connection identification CID_{RS-BS} from the RS to BS is established according to the assigned SFID and the connection identification CID_{RS-BS} from the RS to BS. The mapping relation is saved in the CID re-mapping table of the RS.

After the above steps are done, the present invention may transform the connection the identification of the data packet according to the established mapping relation, and implement the interaction of the data packet between the BS and SS/MSS according to the transformed connection identification. In FIG. 6, the process specifically includes the following steps:

Step1: According to the received data packet sent by SS/MSS, the BS generates a DSC-REQ message and sends the DSC-REQ message to the RS. The DSC-REQ message should include: a Primary Management CID of the SS/MSS.

Step2: The RS searches the CID re-mapping table to obtain the connection identification CID (namely outCID=0x8b) from the RS to SS/MSS with the index which is the connection identification CID of the universal MAC header of the received DSC-REQ message, that is, with the index of inCID=0x3f.

The CID in the DSC-REQ message is transformed from inCID=0x3f to outCID=0x8b, and then is sent to the SS/MSS.

Step3: The SS/MSS replies with a DSC-RSP message, and sends DSC-RSP message to the RS.

The DSC-RSP message should include: the Primary Management CID of the SS/MSS.

Step4: The RS searches the CID re-mapping table to obtain the connection identification CID from the RS to SS/MSS, namely outCID, with the index which is the connection identification CID, namely inCID, of the universal MAC head of the received DSC-RSP message. The CID in the DSC-RSP message is transformed from inCID to outCID, and then is sent to the BS.

Step5: the Anchor BS replies with a DSC-ACK message, and sends DSC-ACK message to the RS.

The DSC-ACK message should include: the Primary Management CID of the SS/MSS.

Step6: The RS searches the CID re-mapping table to obtain the connection identification CID from the RS to SS/MSS, namely outCID=0x8b, with the index which is the connection identification CID, namely inCID=0x3f, of the universal MAC head of the received DSC-ACK message.

The CID in the DSC-ACK message is transformed from inCID=0x3f to outCID=0x8b, and then is sent to SS/MSS.

A fifth embodiment is provided in accordance with the method of the present invention. An example of this embodiment in which a mutual WiMAX DSC flow managing message is established between BS and SS/MSS is illuminated in conjunction with the schematic diagram of the system work principle as shown in FIG. 4.

In FIG. 4, the BS is an Anchor BS. Multi-hop Relay is between the BS and SS/MSS. The SFID is assigned by the BS which locates in the network based on the standard 802.16 when the SS/MSS applies to build a new flow. The CID is assigned by the network in which the serving BS is located in based on the standard 802.16 when the SS/MSS does not move. The CID is assigned by the network in which the target RS is located in based on the standard 802.16 when the SS/MSS moves. When the SS/MSS is switched from the serving RS to target RS, the flow (session) to the SS/MSS doesn't break off. That is, the SFID after assigned will keeps invariant and be managed by the BS. The connection will change dynamically, because the area in which the SS/MSS is located has changed. Such as the connection to the SS/MSS in FIG. 4, the connection CID1 with the serving RS changes to the connection CID2 with the target RS to implement the connecting re-mapping function. The CID3 is the connection between the BS and the serving RS. CID5 is the connection between the serving RS and the target RS.

The interaction process of the data packet between the BS and SS/MSS is implemented by the RS as follows:

First, the RS establishes the mapping relation of the connection between the RS and SS/MSS and the connection between the BS and RS, according to the SFID of the data packet connected by the SS/MSS assigned by the network in which the BS is located in based on the 802.16 standard, the connection identification CID_{RS-SS/MSS} from the RS to SS/MSS assigned by the RS and the connection identification CID_{BS-RS} from the BS to RS assigned by the BS. The process specifically includes the following steps:

Step1: When the SS/MSS is connected to the BS, the network in which the BS is located assigns the SFID/CID to the data packet connected by the SS/MSS based on the 802.16 standard, and establishes the mapping relation of the assigned SFID and the CID_{BS-SS/MSS}. Simultaneously, the mapping relation between the reverse CID_{SS/MSS-BS} and the assigned SFID is established.

Step2: The connection CID_{BS-RS} from the BS to RS is established through the BS in the process of the SS/MSS being switched from the BS to RS. And the new mapping relation of the CID_{BS-RS} and the assigned SFID is established according to the assigned SFID. Simultaneously, the reverse connection CID_{RS-BS} from the RS to BS is established. And the new mapping relation of the CID_{RS-BS} and the assigned SFID is established according to the assigned SFID. The new mapping relation is then saved in the SFID/CID mapping table of the BS.

Step3: The RS establishes the connection CID_{RS-SS/MSS} from the RS to SS/MSS in the process of the SS/MSS being switched from the BS to RS. And the mapping relation of the connection identification CID_{RS-SS/MSS} from the RS to SS/MSS and the connection identification CID_{BS-RS} from the BS to the RS is established according to the assigned SFID and the connection identification CID_{BS-RS} from the BS to RS. Simultaneously, the reverse connection CID_{SS/MSS-RS} from the SS/MSS to RS is established. And the mapping relation of the connection identification CID_{SS/MSS-RS} from the SS/MSS to RS and the connection identification CID_{RS-BS} from the RS to BS is established according to the assigned SFID and the connection identification CID_{RS-BS} from the RS to BS. The mapping relation is saved in the CID re-mapping table of the RS.

Step4: The RS establishes the connection CID_{RS-TBS} from the RS to target RS in the process of the SS/MSS being switched from the RS to target RS. And the mapping relation of the connection identification CID_{RS-TBS} from the RS to target RS and the connection identification CID_{BS-RS} from the BS to RS is established according to the assigned SFID and the connection identification CID_{BS-RS} from the BS to RS. Simultaneously, the reverse connection CID_{TBS-RS} from the target RS to RS is established. And the mapping relation of the connection identification CID_{TBS-RS} from the target RS to RS and the connection identification CID_{RS-BS} from the RS to BS is established according to the assigned SFID and the connection identification CID_{RS-BS} from the RS to BS. The mapping relation is saved in the CID re-mapping table of the RS.

Step5: The target RS establishes the connection identification CID_{TBS-SS/MSS} from the RS to SS/MSS in the process of the SS/MSS being switched from the RS to the target RS. And the mapping relation of the connection identification CID_{TRS-SS/MSS} from the target RS to SS/MSS and the connection identification CID_{RS-TRS} from the RS to target RS is established according to the assigned SFID and the connection identification CID_{RS-TBS} from the RS to target RS. Simultaneously, the reverse connection CID_{SS/MSS-TBS} from the SS/MSS to RS is established. And the mapping relation of the connection identification CID_{SS/MSS-TRS} from the SS/MSS to target RS and the connection identification CID_{TBS-RS} from the target RS to RS is established according to the assigned SFID and the connection identification CID_{TBS-RS} from the target RS to RS. The mapping relation is saved in the CID re-mapping table of the target RS.

After the above steps are done, the present invention may then transform the connection identification of the data packet according to the established mapping relation, and implement the interaction of the data packet between the BS and SS/MSS according to the transformed connection identification. The process specifically includes the following steps:

Step1: After SS/MSS is switched from the BS to RS, the BS receives the data packet, processes the data packet, and sends data packet to the RS through the connection from the BS to RS.

Step2: The RS receives the data packet. The RS searches and obtains connection identification CID_{RS-TRS} from the RS to target RS in the mapping relation between the CID_{BS-RS} and CID_{RS-TRS} according to the CID_{BS-RS} carried by the data packet.

Step3: The data packet is sent to the target RS through the connection from the RS to target RS after the CID_{BS-}R_{S} in the data packet is transformed to CID_{RS-TRS}.

Step4: The target RS receives the data packet. The target RS searches and obtains connection identification CID_{TRS-SS/MSS} from the target RS to SS/MSS in the mapping relation between the CID_{RS-TRS} and CID_{TRS-SS/MSS} according to the CID_{RS-TRS} carried by the data packet.

Step5: The data packet is sent to the SS/MSS through the connection from the target RS to SS/MSS after the CID_{RS-TRS} in the data packet is transformed to CID_{TRS-SS/MSS}.

Step6: The SS/MSS replies with another data packet to the target RS through the connection from the SS/MSS to the target RS after receiving the data packet.

Step7: The target RS receives the data packet. The target RS searches and obtains connection identification CID_{TRS-RS} from the target RS to RS in the mapping relation between the CID_{TRS-RS} and CID_{SS/MSS-TRS} according to the CID_{SS/MSS-TRS} carried by the data packet.

Step8: The data packet is sent to corresponding RS through the connection from the target RS to RS after the CID_{SS/MSS-TRS} in the data packet is transformed to CID_{TRS-RS}.

Step9: The RS receives the data packet. The RS searches and obtains connection identification CID_{RS-BS} from the RS to BS in the mapping relation between the CID_{RS-BS} and CID_{TRS-RS} according to the CID_{TRS-RS} carried by the data packet.

Step10: The data packet is sent to corresponding BS through the connection from the RS to BS after the CID_{TRS-RS} in the data packet is transformed to CID_{RS-BS}.

The fourth embodiment which is provided in accordance with the method of the present invention includes the steps described below in detail in conjunction with FIG. 2.

Step1: The SFID/CID mapping table is established.

The BS or SS/MSS originates an operation of flow establishing when the SS/MSS is connected to the BS. The data packet connected by the SS/MSS is assigned the flow identify SFID and the connection identification CID by the network in which the BS is located in based on the standard 802.16, such as SFID=0x7426 and CID=0x54. Then the SFID/CID is mapped when the flow is active. The mapping relation of the assigned SFID and the CID_{BS-SS/MSS} is established, such as SFID=0x7426 corresponding to CID=0x54. Finally, the mapping relation is saved in the SFID/CID mapping table as shown in Table 1.

TABLE 1

| NO. | SFID | CID | QoS | . . . |
|---|---|---|---|---|
| 1 | 0x7426 | 0x54 | rt-polling | . . . |
| | | (namely CID2) | | |
| 2 | 0x7729 | 0x18 | BE | . . . |
| 3 | . . . | . . . | . . . | . . . |

Step2: SFID/CID mapping table is updated dynamically.

First, in the process of the SS/MSS being switched from the BS to RS, the connection CID_{BS-RS} from the BS to RS is established through the BS. Such as CID3=0x3f is assigned by the BS. Then the new mapping relation of the CID_{BS-RS} and the assigned SFID is established according to the assigned SFID in step1. A mapping relation as CID3=0x3f is distributed by BS corresponding to former flow SFID=0x7426. Finally, the SFID/CID mapping table is updated dynamically by the BS. For example, SFID=0x7426 corresponding to CID=0x54 is updated to CID=0x3f, and the SFID remains the same. The mapping table as updated is as shown in Table 2.

TABLE 2

| NO. | SFID | CID | QoS | . . . |
|---|---|---|---|---|
| 1 | 0x7426 | 0x3f | rt-polling | . . . |
| | | (namely CID3) | | |
| 2 | 0x7729 | 0x18 | BE | . . . |
| 3 | . . . | . . . | . . . | . . . |

Step3: CID re-mapping table is established.

The RS establishes the connection CID_{RS-SS/MSS} from the RS to SS/MSS in the process of the SS/MSS handoff from the BS to RS. For example, a connection such as CID2=0x8b is assigned by the RS. The mapping relation of the connection identification CID_{RS-SS/MSS} from the RS to SS/MSS and the connection identification CID_{BS-RS} from the BS to the RS is established according to the assigned SFID in step 1 and CID_{BS-RS} in step2. That is, the RS establishes relay connection of the connection CID2 from the RS to SS/MSS and the connection CID3=0x3f from BS to RS. CID re-mapping table is established as shown in Table 3.

TABLE 3

| NO. | SFID | inCID | outCID | QoS | . . . |
|---|---|---|---|---|---|
| 1 | 0x7426 | 0x3f | 0x8b | rt-polling | . . . |
| | | (namely CID3) | (namely CID2) | | |
| 2 | 0x1694 | 0x49 | 0xa1 | BE | . . . |
| 3 | . . . | . . . | . . . | . . . | . . . |

The corresponding relation of inCID and outCID has been established in the RS after the above steps. The CID of the data packet is transformed based on the established corresponding relation when the RS receives the data packet from the SS/MSS or BS. The data packet is sent according to the transformed CID. The implementing process concretely includes:

Step4: CS Service Access Point (SAP) and CS of the BS process the downstream data packet.

First, an IP package, data frame of the second layer or signaling message which enters CS of the BS from the CS SAP of the BS is distributed according to the 802.16 classification regulation. And then the SFID/CID mapping table is sought, and the corresponding connection of the data packet is confirmed according to the received data packet after classified. For example, a connection whose SFID is 0x7426 corresponds to the connection CID3 whose CID is 0x3f. Finally, the data packet is sent to the MAC SAP of MAC CPS of the BS after PHS (PHS is optional).

Step5: MAC CPS of the BS and SS/MSS process the downstream data packet.

MAC Service Data Unit (SDU) is queued by the MAC CPS of the BS according to the CID. And the MAC SDU is out of the queue by QoS scheduling, processed by concatenation, fragmentation or packing. A subheader is added. The payload is encrypted. A MAC frame header is added (fill 0x3f in the CID of the frame header). And then the MAC PDU is generated. The MAC PDU is sent to the PHY SAP of the BS PHY layer.

Step6: The PHY SAP of the BS PHY layer is in charge of sending MAC PDU to PHY SAP of PHY layer of the opposite side RS.

Step7: The SS and the MAC CPS of the RS process the upstream data packet.

First, the SS and the MAC CPS of the RS remove the MAC frame header of MAC PDU, and decrypt the payload. Then, MAC PDU is received and processed to gain a MAC SDU message by de-concatenation, de-fragmentation or unpacking etc.

Step8: The SS and the MAC CPS of the RS re-map CID of the upstream data packet.

After receiving the MAC SDU message, the SS and the MAC CPS of the RS search the CID re-mapping table (as shown in Table 3) to obtain the connection identification CID, namely outCID=0x8b, from the RS to SS/MSS with the index which is the connection identification CID, namely inCID=0x3f, in the 802.16 MAC frame header.

The message containing the CID needs CID transferring processing. The CID in the message is transformed from inCID=0x3f to outCID=0x8b.

Step9: The SS and the MAC CPS of the RS process the downstream data packet.

The received MAC SDU is queued according to outCID=0x8b. And the MAC SDU is out of the queue by QoS scheduling, processed by concatenation, fragmentation or packing. A subheader is added. The payload is encrypted. The MAC frame header is added (by filling 0x8b in the CID of the frame header). And the MAC PDU data packet is generated. The MAC PDU data packet is sent to the PHY SAP of PHY layer of the RS.

Step10: The PHY SAP of PHY layer of the RS is in charge of sending the MAC PDU data packet to the PHY SAP of PHY layer of the opposite side SS/MSS to process.

The fourth embodiment provided in accordance with the method of the present invention is described in detail in conjunction with FIG. 3. The differences between the description in conjunction with FIG. 3 and description in conjunction with FIG. 2 are that:

Step8: The MAC SSCS of the RS re-maps the CID of the data packet.

The MAC SSCS of the RS searches the CID re-mapping table, as shown in Table 3, to obtain the connection identification CID, namely outCID=0x8b, from RS to SS/MSS with the index which is the connection identification CID, namely inCID=0x3f, of the received 802.16 MAC frame header.

The rest of the steps are the same with the fourth embodiment. The detailed description is omitted.

The fifth embodiment which is provided in accordance with the method of the present invention is described in detail in conjunction with the principle diagram as shown in FIG. 4 and the function frame diagram as shown in FIG. 2.

The transferring flowchart of the data packet by the first RS is the same with the fourth embodiment when SS/MSS connects to BS and SS/MSS switches from the BS to the first RS (serving RS in FIG. 2) under the system function frame in FIG. 2. The detail description is omited. The status of the SS/MSS switching from the serving RS to the target RS is considered infra. Before switching, the SFID/CID mapping table has existed in the BS as shown in Table 4, and the CID re-mapping table has existed in the serving RS as shown in Table 5.

TABLE 4

| NO. | SHD | CID | QoS | . . . |
|---|---|---|---|---|
| 1 | 0x7426 | 0x3f | rt-polling | . . . |
| | | (namely CID3) | | |
| 2 | 0x7729 | 0x18 | BE | . . . |
| 3 | . . . | . . . | . . . | . . . |

TABLE 5

| NUM. | SFID | inCID | outCID | QoS | . . . |
|---|---|---|---|---|---|
| 1 | 0x7426 | 0x3f | 0x8b | rt-polling | . . . |
| | | (namely CID3) | (namely CID2) | | |
| 2 | 0x1694 | 0x49 | 0xa1 | BE | . . . |
| 3 | . . . | . . . | . . . | . . . | . . . |

In conjunction with the diagram of FIG. 4, the process for transferring a flowchart of data packets by the RS specifically includes the steps of:

Step1: The CID re-mapping table of the serving RS is updated dynamically.

When the SS/MSS switches from the serving RS to the target RS, the serving RS establishes the connection CID5 form the serving RS to the target RS in the process of switching. A connection such as CID5=0xd2 is assigned by the BS and corresponds to former flow SFID=0x7426. The serving RS dynamically updates the CID re-mapping table of the data packet. A connection such as inCID=0x3f corresponding to CID3=0x8b is updated as corresponding to CID5=0xd2 shown in Table 6.

TABLE 6

| NO. | SFID | inCID | outCID | QoS | . . . |
|---|---|---|---|---|---|
| 1 | 0x7426 | 0x3f | 0xd2 | rt-polling | . . . |
| | | (namely CID3) | (namely CID5) | | |
| 2 | 0x1694 | 0x49 | 0xa1 | BE | . . . |
| 3 | . . . | . . . | . . . | . . . | . . . |

Step2: The CID re-mapping table of data packet is established in the target RS.

The target RS establishes the connection CID4 form the target RS to the SS/MSS in the process of the SS/MSS switching from the serving RS to the target RS. A connection such as CID4=0x11 is assigned by the target RS. The mapping relation of the connection identification from the serving RS to the target RS and the connection identification from the target RS to the SS/MSS is established according to former flow SFID and CID5, such as CID5=0xd2, from the serving RS to target RS. The CID re-mapping table is established as shown in Table 7.

TABLE 7

| NO. | SFID | inCID | outCID | QoS | . . . |
|---|---|---|---|---|---|
| 1 | 0x7426 | 0xd2 | 0x11 | rt-polling | . . . |
| | | (namely CID5) | (namely CID4) | | |
| 2 | 0x4575 | 0x34 | 0x75 | Nrt-polling | . . . |
| 3 | . . . | . . . | . . . | . . . | . . . |

After the SS/MSS finished switching from the serving RS to the target RS, the SSCS of BS processes the downstream data packet that is to perform step 3:

Data packets, such as IP package, data frame of the second layer or signaling message, which enter the SSCS of the BS from the CS SAP are classified according to the 802.16 classification regulation. And then the SFID/CID mapping table is sought and the corresponding connection of the data packet is confirmed according to the received data packets after classified. A connection such as the flow whose SFID is 0x7426 corresponds to the connection CID3 whose CID is 0x3f. Finally, the data packet is sent to MAC SAP of MAC CPS of BS after optional Payload Header Suppression.

Step4: The SS and the MAC CPS of the BS process the data packet.

The MAC SDU is queued by MAC CPS of the BS according to the CID. And the MAC SDU is out of the queue through QoS scheduling, processed by concatenation, fragmentation or packing. A subheader is added. The payload is encrypted. The MAC frame header is added (fill 0x3f in the CID of the frame header). Finally, a MAC PDU message flow is generated and is sent to the PHY SAP of PHY layer of the BS.

Step5: The PHY SAP of PHY layer of the BS is in charge of sending the MAC PDU message flow to the PHY SAP of the PHY layer of the opposite side RS.

Step6: The SS and the MAC CPS of the serving RS execute receiving process to the upstream data packet.

First, the SS and the MAC CPS of the serving RS remove the MAC frame header of the MAC PDU, and decrypt the payload. And then the MAC PDU is received and processed to gain the MAC SDU data packet by de-concatenation, de-fragmentation or unpacking etc.

Step7: The SS and the MAC CPS of the serving RS re-map CID of the data packet.

The SS and the MAC CPS of the serving RS search the CID re-mapping table of the serving RS to obtain the connection identification CID, namely outCID=0xd2, from the serving RS to the target RS with the index which is the connection identification CID (namely inCID=0x3f) of the 802.16 MAC frame header.

The message contains a CID message that needs CID transferring processing. That is, the CID in the message is transformed from inCID=0x3f to outCID=0xd2.

Step8: The SS and the MAC CPS of the serving RS takes sending disposal to the downstream data packet.

The received MAC SDU data packet is queued by the SS and the MAC CPS of the serving RS according to the outCID=0xd2. And then the MAC SDU is out of the queue through QoS scheduling, processed by concatenation, fragmentation or packing. A subheader is added. The payload is encrypted. The MAC frame header is added (fill 0xd2 in the CID of the frame header). And then the MAC PDU data packet is generated. The MAC PDU data packet is sent to PHY SAP of the RS PHY layer.

Step9: The PHY SAP of PHY layer of the serving RS is in charge of sending the MAC PDU to PHY SAP of the PHY layer of the opposite side target RS.

Step10: The SS and the MAC CPS of target RS execute receiving process to the upstream data packet.

First, the SS and the MAC CPS of the target RS remove the MAC frame header of the MAC PDU, and decrypt the payload. And then the MAC PDU is received and processed to gain the MAC SDU data packet by de-concatenation, de-fragmentation or unpacking etc.

Step11: The CID is re-mapped by the MAC CPS and SS/MSS of the target RS.

The CID re-mapping table of the target RS is searched to obtain the connection identification CID (namely outCID=0x11) from the target RS to SS/MSS with the index which is the connection identification CID (namely inCID=0xd2) of the received 802.16 MAC frame header.

The message containing CID needs CID transferring processing. The CID in the message is transformed from inCID=0xd2 to outCID=0x11.

Step12: The SS and the MAC CPS of the target RS dispose of the downstream data packet.

The received MAC SDU data packet is queued according to the outCID=0x11. And then the MAC SDU is out of the queue through QoS scheduling, processed by concatenation, fragmentation or packing. A subheader is added. The payload is encrypted. The MAC frame header is added (fill 0x11 in the CID of the frame header). And then the MAC PDU data packet is generated. The MAC PDU data packet is sent to PHY SAP of PHY layer of the target RS.

Step13: The PHY SAP of PHY layer of the target RS is in charge of sending the MAC PDU to the PHY SAP of PHY layer of the opposite side SS/MSS to process.

The fifth embodiment which is provided in accordance with the method of the present invention is described in detail in conjunction with the principle diagram in FIG. 4 and the system function frame diagram in FIG. 3. The differences between the description in conjunction with FIG. 4 and the description in conjunction with FIG. 2 relate to Step7 and Step11. Step7 and Step11 are amended as follows:

Step7: The MAC SSCS of the serving RS re-maps the CID of the data packet.

The MAC SSCS of the serving RS search the CID re-mapping table of the serving RS to obtain the connection identification CID (namely outCID=0xd2) from the serving RS to the target RS with the index which is the connection identification CID, namely inCID=0x3f of the received 802.16 MAC frame header.

Step11: The MAC SSCS of the target RS re-maps the CID of the data packet.

The MAC SSCS of the target RS searches the CID re-mapping table of the target RS to obtain the connection identification CID (namely outCID=0x11) from the target RS to SS/MSS with the index which is the connection identification CID, namely inCID=0xd2, of the received 802.16 MAC frame header.

According to the embodiments of the present invention as described above, the following is noteworthy:

1. The flow distribution managing function is only realized in the BS. The RS doesn't realize the flow distribution managing function. The RS only realizes the connection re-mapping function. The BS is in charge of processing a series of 802.16 MAC layer flow managing messages, such as Dynamic Service Addition (DSA), Dynamic Service Changing (DSC), Dynamic Service Deletion (DSD), and DSA/DSC/DSD Received (DSX-RVD), and maintaining the flow managing state machines. The RS is only in charge of transferring the messages, which reduces the complexity of the RS effectively.

2. Re-mapping is connected by the second layer to solve the problem of multi-hop relay. Because that there is no need to introduce the technology of complicated routing in the third layer, the complexity of WiMAX transferring network is reduced.

3. The SS/MSS transforming between the BS and RS or between different RS is supported.

4. The SFID and the relative properties (i.e. QoS binding) of flow can be uniformly managed in the BS. The move of the flow status is not needed in the switching process. The switch time delay can be decreased effectively.

5. The SFID keeps invariant in the switching process. The service continuity of special flow can be ensured.

Though illustration and description of the present invention have been given with reference to exemplary embodiments thereof, it should be appreciated by persons of ordinary skill in the art that various changes in forms and details can be made without deviation from the spirit and scope of this disclosure, which are defined by the appended claims. The invention is intended to include all foreseeable equivalents to the claimed elements as described in reference to FIGS. 2-6.

What is claimed is:

1. A method for managing service flows based on Relay Station (RS), comprising the steps of:
establishing a mapping relation between a first connection identification and a second connection identification in a RS;
transforming the first connection identification in a data packet to the second connection identification, according to the established mapping relation; and
implementing a data packet interaction between the RS and a base station (BS), or a data packet interaction between the RS and other RS, or a data packet interaction between the RS and a Subscriber Station/Mobile Subscriber Station (SS/MSS), according to the transformed second connection identification.

2. The method according to claim 1, wherein the process of establishing a mapping relation comprises:
in an RS handoff process, establishing, by the BS, the first connection identification from the BS to the RS, establishing the second connection identification in the RS, and establishing the mapping relation between the first connection identification and the second connection identification in the RS.

3. The method according to claim 2, wherein the process of establishing a mapping relation further comprises the steps of:
establishing a mapping relation between the first connection identification and a Service Flow identification (SFID) assigned to the SS/MSS by the BS, according to the first connection identification established by the BS and the SFID; and
establishing a mapping relation between the second connection identification and the first connection identification, according to the second connection identification in the RS, the SFID and the first connection identification.

4. The method according to claim 2, wherein the implementing a data packet interaction comprises the steps of:
sending, by the BS, a data packet to the RS, after the SS/MSS accomplishes a handoff from the BS to the RS;
receiving the data packet, by the RS, and searching and obtaining the second connection identification in the mapping relation between the first connection identification and the second connection identification, according to the first connection identification carried by the data packet; and
sending the data packet to another BS or to the SS/MSS related with the second connection identification, after transforming, by the RS, the first connection identification carried by the data packet to the second connection identification.

5. The method according to claim 3, wherein the step of implementing a data packet interaction comprises:
sending, by the BS, a data packet to the RS, after the SS/MSS accomplishes a handoff from the BS to the RS;
receiving the data packet, by the RS, and searching and obtaining the second connection identification in the mapping relation between the first connection identification and the second connection identification, according to the first connection identification carried by the data packet; and
sending the data packet to another BS or the SS/MSS related with the second connection identification, after transforming, by the RS, the first connection identification carried by the data packet to the second connection identification.

6. The method according to claim 4, wherein the step of implementing a data packet interaction further comprises:
sending, by another BS or the SS/MSS, the data packet to the RS;
receiving the data packet, by the RS, and searching and obtaining the first connection identification in the mapping relation between the first connection identification and the second connection identification, according to the second connection identification carried by the data packet; and
sending the data packet to the BS, after transforming the second connection identification carried by the data packet to the first connection identification.

7. The method according to claim 1, wherein in the process of a SS/MSS handoff from the BS to the RS and the process of handoff form the RS to a target RS, the process of establishing a mapping relation comprises the steps of:
in the process of the SS/MSS handoff from the BS to the RS, establishing the first connection identification from the BS to the RS by the BS, establishing the second connection identification from the RS to the target RS in the RS, and establishing the mapping relation between the first connection identification and the second connection identification according to the first connection identification and the SFID assigned to the SS/MSS by the BS; and
in the process of the SS/MSS handoff from the RS to the target RS, establishing a third connection identification from the target RS to the SS/MSS in the target RS, and establishing a mapping relation between the third connection identification and the second connection identification according to the assigned SFID and the second connection identification from the RS to the target RS.

8. The method according to claim 7, wherein the implementing data packet interaction comprises the steps of:
sending, by the BS, a data packet to the RS, after the SS/MSS accomplishing the handoff from the BS to the RS;
receiving the data packet, by the RS, and obtaining the second connection identification, according to the first connection identification carried by the data packet and the mapping relation between the first connection identification and the second connection identification;
sending the data packet to the target packet, according to the second connection identification obtained by the RS;
receiving the data packet, by the target RS, and obtaining the third connection identification, according to the second connection identification carried by the data packet and the mapping relation between the second connection identification and the third connection identification; and
sending the data packet to the SS/MSS, by the target RS, according to the obtained third connection identification.

9. The method according to claim 1, wherein the first connection identification and the second connection identification comprise one of:
the connection identification between the BS and the RS, the connection identification between different RSs, and the connection between the RS and the SS/MSS.

10. The method according to claim 2, wherein the first connection identification and the second connection identification comprise one of:
the connection identification between the BS and the RS, the connection identification between different RSs, and the connection between the RS and the SS/MSS.

11. The method according to claim 3, wherein the first connection identification and the second connection identification comprise one of:
the connection identification between the BS and the RS, the connection identification between different RSs, and the connection between the RS and the SS/MSS.

12. The method according to claim 9, wherein the first connection identification and/or the second connection identification are/is assigned by the BS or RS.

13. A Relation Station (RS) managing service flows, comprising:
a physical (PHY) layer configured to receive and send a data packet; and
a Media Access Control (MAC) layer configured to execute a MAC layer process to the data packet received by physical layer, to transform a first connection identification carried by the data packet to a second connection identification, and to send the data packet to the PHY layer.

14. The RS according to claim 13, wherein the MAC layer comprises:
a MAC Common Part Sublayer (MAC CPS) configured to execute a MAC common part process to the data packet and to send the processed data packet to a connection re-mapping unit;
a connection re-mapping unit, set in the MAC CPS, configured to transform the first connection identification in the processed data packet to the second connection identification and send the data packet to a Security Sublayer (SS); and
a Security Sublayer (SS) configured to execute a security process, and send the processed data packet to the PHY layer for processing.

15. The RS according to claim 13, wherein the first connection identification and the second connection identification comprise one of:
the connection identification between the BS and the RS, the connection identification between different RSs, and the connection between the RS and the SS/MSS.

16. The RS according to claim 14, wherein the first connection identification and the second connection identification comprise one of:
the connection identification between the BS and the RS, the connection identification between different RSs, and the connection between the RS and the SS/MSS.

17. The RS according to claim 15, wherein at least one of the first connection identification and the second connection identification is assigned by the BS or RS.
